(19) United States
(12) Patent Application Publication
(10) Pub. No.: US 2026/0016838 A1
(43) Pub. Date: Jan. 15, 2026

(54) SYSTEMS AND METHODS FOR TRACKING A VEHICLE WITH AN UNMANNED AERIAL VEHICLE

(71) Applicant: Toyota Motor Engineering & Manufacturing North America, Inc., Plano, TX (US)

(72) Inventor: John-Michael McNew, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/770,869

(22) Filed: Jul. 12, 2024

(51) Int. Cl. G05D 1/689; G01C 21/36; G05D 1/622; G05D 1/686; G05D 105/80; G05D 109/25

(52) U.S. Cl. CPC G05D 1/689; G01C 21/3691; G05D 1/622; G05D 1/686; G05D 2105/80; G05D 2109/254

(57) ABSTRACT

Systems, methods, and other embodiments described herein relate to tracking vehicle movement from an unmanned aerial vehicle (UAV) and altering a flight path to capture images of an obstacle. In one embodiment, a method includes 1) tracking a location and a pose of a moving vehicle to which a UAV is operatively connected and 2) controlling the UAV based on the location and the pose of the moving vehicle to fly along a flight path at a predetermined distance relative to the moving vehicle. The method also includes 1) identifying, based on sensor data, an obstacle along a path traveled by the moving vehicle and 2) controlling the UAV to depart from the flight path to capture images of the obstacle.

### TECHNICAL FIELD

The subject matter described herein relates, in general, to tracking a vehicle via an unmanned aerial vehicle (UAV) and, more particularly, to deviating from a vehicle-tracking flight path to capture images of an obstacle along a path the vehicle is traveling.

### BACKGROUND

Vehicles are a practical tool that quickly and comfortably transport people across great distances. Vehicles can transport people and/or cargo across an extensive network of roads, thus facilitating economic and social connections between communities that are otherwise largely separated. Vehicles in various forms (e.g., personal vehicles, public transport buses, and cargo-hauling tractors and trailers) are commonplace in many locations across the globe and used by tens of millions of people daily.

Since their introduction, vehicles have also been used as a source of recreation. For example, automobile races can be found in most countries across the globe and are popular with motorists and spectators alike. As another example, vehicles may be used in off-road environments where an individual navigates a vehicle over uneven, rocky, muddy, steep, and otherwise difficult-to-navigate terrain. Navigating across this terrain and around the obstacles and features found thereon may be complex, but it is also a source of enjoyment for many people.

### SUMMARY

In one embodiment, example systems and methods relate to a manner of improving UAV-based capture of images/video streams of a vehicle navigating a road or trail.

In one embodiment, a UAV control system for capturing images/video streams of a moving tracked vehicle is disclosed. The UAV control system includes one or more processors and a memory communicably coupled to the one or more processors. The memory stores instructions that, when executed by the one or more processors, cause the one or more processors to 1) track a location and a pose of a moving vehicle to which a UAV is operatively connected and 2) control the UAV based on the location and the pose of the moving vehicle to fly along a flight path at a predetermined distance relative to the moving vehicle. The memory also stores instructions that, when executed by the one or more processors, cause the one or more processors to 1) identify, based on sensor data, an obstacle along a path traveled by the moving vehicle and 2) control the UAV to depart from the flight path to capture images of the obstacle.

In one embodiment, a non-transitory computer-readable medium for capturing images/video streams of a moving vehicle and including instructions that, when executed by one or more processors, cause the one or more processors to perform one or more functions is disclosed. The instructions include instructions to 1) track a location and a pose of a moving vehicle to which a UAV is operatively connected and 2) control the UAV based on the location and the pose of the moving vehicle to fly along a flight path at a predetermined distance relative to the moving vehicle. The instructions also include instructions to 1) identify, based on sensor data, an obstacle along a path traveled by the moving vehicle and 2) control the UAV to depart from the flight path to capture images of the obstacle.

In one embodiment, a method for capturing images/video streams of a moving vehicle is disclosed. In one embodiment, the method includes 1) tracking a location and a pose of a moving vehicle to which a UAV is operatively connected and 2) controlling the UAV based on the location and the pose of the moving vehicle to fly along a flight path at a predetermined distance relative to the moving vehicle. The method also includes 1) identifying, based on sensor data, an obstacle along a path traveled by the moving vehicle and 2) controlling the UAV to depart from the flight path to capture images of the obstacle.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle and a vehicle-tracking UAV navigating a dirt trail.

FIG. 2 illustrates a UAV control system controlling a UAV to track a vehicle and capture vehicular environment images/video streams.

FIG. 3 illustrates one embodiment of the UAV control system that is associated with capturing images of a vehicular environment by a vehicle-tracking UAV.

FIGS. 4A and 4B depict a UAV flight adjustment based on a vehicle pose.

FIG. 5 depicts a UAV deviating from a flight path to capture images of an obstacle.

FIG. 6 depicts a UAV deviating from a flight path to capture images of an obstacle.

FIGS. 7A and 7B depict a UAV deviating from a flight path as a vehicle travels down a slope.

FIG. 8 depicts a UAV following behind the vehicle to avoid an obstacle.

FIG. 9 illustrates a flowchart for one embodiment of a method that is associated with controlling the UAV to track and capture images in a vehicular environment.

FIG. 10 illustrates a UAV leading a vehicle along a path.

### DETAILED DESCRIPTION

Systems, methods, and other embodiments associated with improving UAV-assisted vehicle operation are disclosed herein. As described above, personal vehicles, public transportation, or cargo haulers are used daily by millions of the world's inhabitants. Vehicles are sometimes used recreationally to navigate terrain with obstacles and features that test a driver's skill and experience. The obstacles vary widely and include, but are not limited to, pitched surfaces, boulders and other obstacles, low clearance regions, and loose debris on the road or trail surface.

The obstacles and features, while navigable, call for additional driver attention and focus. If not given appropriate attention, such obstacles and features may cause damage to the vehicle and injury to a passenger. However, when navigating a road or trail, limits on a driver's field of view of the road or trail and obstacles may compromise the driver's ability to safely and effectively navigate features/obstacles of the road or trail. For example, an obstacle that requires particular attention and preparation may be around a curve of the road or trail out of the field of view of the driver. As another example, drivers may be unable to see the obstacles immediately adjacent to the vehicle.

Accordingly, the present specification describes a UAV that is operatively connected to the vehicle and captures images of the environment surrounding the vehicle. Specifically, the UAV tracks the location of the vehicle and flies a predetermined and fixed distance away from the vehicle. In some examples, a camera of the UAV is directed towards the vehicle to capture images of the vehicle as it encounters obstacles along the road or trail. In other examples, the camera is directed away from the vehicle, capturing images of the environment that may not otherwise be obtainable from the vehicle's cameras/sensors. These forward-facing images may be provided to the driver as guidance imagery.

In an example, the system estimates the vehicle's position and motion using data from vehicle motion sensors, UAV and vehicle global positioning system (GPS) sensors, UAV motion sensors, and a UAV camera feed when pointed at the vehicle. Using the vehicle position and motion information, the UAV control system maintains the UAV at a fixed distance relative to the moving vehicle. In one approach, the system controls the UAV to fly a fixed distance ahead of the vehicle but in the center of the trail, road, or path. The trail, road, or path is recognized by camera vision techniques (e.g., texture clues, three-dimensional (3D) visual simultaneous location and mapping (SLAM), etc.) and/or available maps.

In either case (e.g., forward-facing capture or vehicle capture), the images/video stream captured by the camera may be transmitted to a human-machine interface (HMI) in the vehicle to provide visual information about the surroundings of the vehicle to a passenger or driver within the vehicle.

In a particular example, the orientation of the UAV relative to the vehicle is based on the pose of the vehicle. That is, rather than simply tracking the longitude and latitude position of the vehicle and providing tracking-based images/video streams, the UAV control is further based on the angular characteristics (e.g., yaw, pitch, and roll) of the vehicle. For example, a vehicle may be traveling down a hill. In this example, a UAV in front of and level with the vehicle may be unable to capture a front view of the vehicle and road or trail because of the sloped ground surface and may instead capture images primarily illustrating the top of the vehicle. As such, certain road or trail features, such as ruts and boulders, may not be clearly depicted on the HMI. Accordingly, in this example, the UAV control system may change the height of the UAV as well as the angle of the camera based on the detected pitch of the road or trail such that the UAV can capture front-view images of the vehicle even when the vehicle is pitched downward.

Still further, when an obstacle is encountered that may warrant additional driver attention, the UAV deviates from its flight path to capture images of the environment of the vehicle in the region of the detected obstacle. That is, the system can reposition the UAV to capture images of an obstacle near the vehicle. Vehicle sensors or UAV sensors may sense this obstacle. For example, ultrasonic proximity sensors on a vehicle or UAV may detect tight gully, canyon, or ravine walls, a sloped surface, and any other type of obstacle. When near the obstacle, the UAV transmits images to the HMI of the vehicle to provide additional visual information to the driver to promote safe navigation of the obstacles.

In this way, the disclosed systems, methods, and other embodiments may improve vehicular navigation, particularly on road or trail with obstacles/features that may obscure the field of view of the driver and/or that warrant additional attention and inspection while navigating. Without such a system, a driver may navigate these obstacles with limited information (i.e., limited to the driver's field of view and the vehicle sensor's field of view). The additional visual information the UAV provides facilitates an overall greater perception of the environment so that the driver may more safely and efficiently navigate certain paths, such as dirt roads.

Note that in the present specification and in the appended claims, the vehicle is described as traversing a path, which may be a route along any type of road or trail. That is, the present system may be implemented as a vehicle travels on paved roads, or dirt off-road trails.

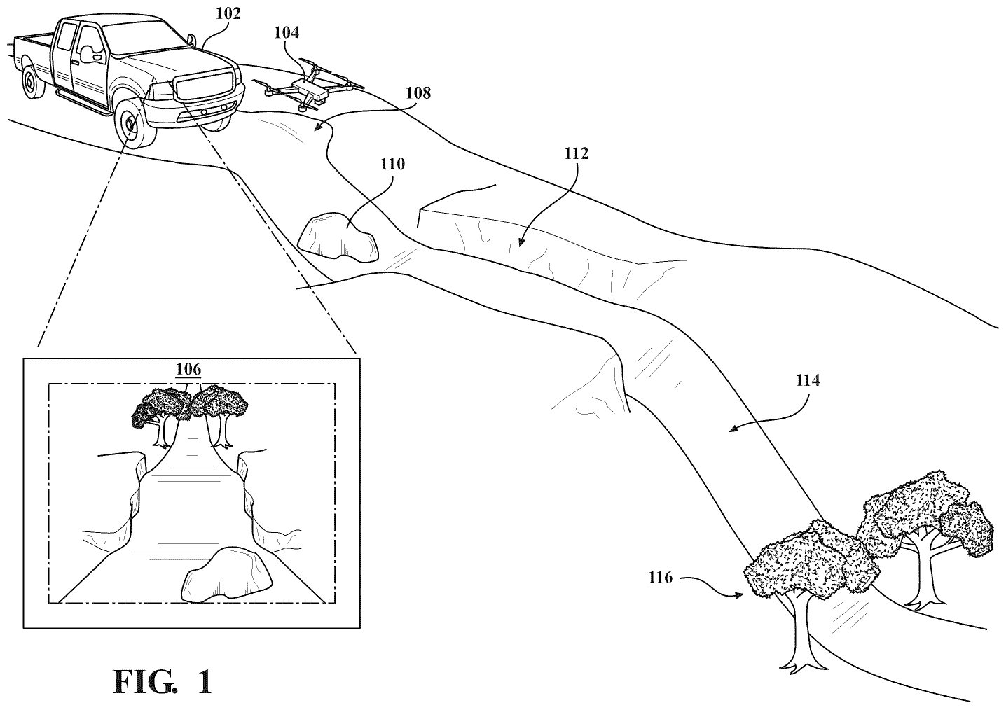

FIG. 1 illustrates one embodiment of a vehicle 102 and a vehicle-tracking UAV 104 navigating an offroad trail. It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, the implemented UAV control system performs methods and other functions as disclosed herein relating to improving UAV-assisted vehicle navigation.

As described above, while navigating certain paths, such as offroad trails, a vehicle 102 may encounter many obstacles. An obstacle refers to any feature of a road or trail surface that may present a challenge. Examples of obstacles include but are not limited to side-sloped hills 108, boulders or other obstructions 110 or debris on the trail, gullies, ravines, or canyons with narrow sidewalls 112, inclined/declined hills 114 (whether upward or downward sloping), and low-clearance areas 116, for example as may be formed by overhanging branches. While particular reference is made to particular obstacles, the vehicle 102 may encounter any number and type of obstacles, such as soft sand, ice, loose gravel/debris, ruts, and others. In each of these examples, the obstacles may be detected by a sensor system of the vehicle 102 and/or the UAV 104, as described below.

A clear and complete perception of the obstacles enables safe and efficient navigation along the trail. However, it may be that the obstacles are not readily visible to the driver and vehicle sensors or that the driver and/or vehicle sensors may perceive the obstacles in a limited fashion. For example, as the vehicle 102 approaches a hill 114, the driver may not be able to see over the crest of the hill 114 nor the features that are on the hill 114 or immediately after the hill 114. As another example, as the vehicle 102 travels over a boulder, the boulder may pass under the vehicle 102 and out of the field of view of the driver and vehicle cameras.

Under these conditions, a UAV 104 may provide the driver of the vehicle 102 with images/video streams of the path (e.g., the road or trail the vehicle 102 is traveling across) and obstacles that would otherwise be unavailable. Specifically, the UAV 104 flies a predetermined distance away from the vehicle 102. In one example, the UAV 104 may capture images of the environment surrounding the vehicle 102. Specifically, the UAV 104 may capture images of the road or trail in front of the vehicle 102 to provide guidance imagery to the vehicle driver. In another example, the UAV 104 may face the vehicle 102 and capture images/video streams of the vehicle 102 as the vehicle 102 navigates the road or trail. When no deviation-triggering obstacles are detected, the UAV 104 may fly a predetermined distance from the vehicle 102, providing vehicle or guidance imagery to the driver via the HMI 106. When vehicle or UAV sensors detect an obstacle, the UAV 104 may deviate from this fixed distance to fly to a region around the obstacle to provide the vehicle driver with a more focused view. Thus, a driver is provided with a field of view greater than the field of view of the driver and the vehicle sensors.

As such, the vehicle 102 includes an HMI 106, which is an interface through which commands may be provided to the UAV 104 and through which images captured by a camera of the UAV 104 are provided to the driver. In an example, the HMI 106 includes a display portion on which images or video streams captured by the UAV 104 are visually presented to a user. The HMI 106 may also include interface elements through which a user may enter UAV commands. Example commands include 1) flight commands such as elevation commands, directional commands, yaw commands, etc., and 2) camera commands such as gimbal angle commands, focal length commands, etc.

Via the HMI 106, a driver may establish the distance and/or location of the UAV 104 relative to the vehicle 102. In one example, the driver may enter a value for the predetermined distance between the UAV 104 and the vehicle 102. In another example, the driver may use flight controls displayed on the HMI 106 to position the UAV 104 at a particular location relative to the vehicle 102. In either case, the UAV control system may maintain the UAV 104 at the selected predetermined distance and location during flight.

As another example of a specific command, the driver may select whether the UAV 104 is in a front-facing or vehicle-facing mode. Note that while reference is made to particular commands, the HMI 106 may provide other command inputs in accordance with the principles described herein.

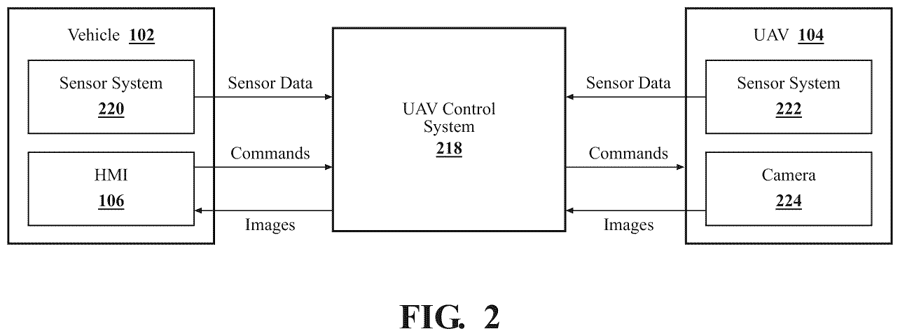

FIG. 2 illustrates a UAV control system 218 controlling a UAV 104 to track a vehicle 102 and capture vehicular environment images/video streams. The UAV control system 218 manages data transmission between the vehicle 102 and the UAV 104 to enable UAV-assisted vehicular travel.

In an example, the UAV control system 218 is within the vehicle 102. In another example, the UAV control system 218 is remote from the vehicle 102 and receives information from the vehicle 102 via a wireless communication system. That is, the UAV control system 218, in various embodiments, is implemented partially within the vehicle 102, and as a cloud-based service. For example, in one approach, functionality associated with at least one module of the UAV control system 218 is implemented within the vehicle 102, while further functionality is implemented within a cloud-based computing system. Thus, the UAV control system 218 may include a local instance at the vehicle 102 and a remote instance that functions within the cloud-based environment.

The vehicle 102 includes a sensor system 220 that includes a variety of sensors, the output of which may be used to guide the UAV 104. Specifically, the sensor system 220 output may be used to 1) determine the location of the vehicle 102, 2) determine a pose the vehicle 102, and 3) identify obstacles in the vicinity of the vehicle 102. Various examples of different types of sensors will be described herein. However, it will be understood that the embodiments are not limited to the particular sensors described. In various configurations, the sensor system 220 includes one or more vehicle sensors and/or one or more environment sensors. The vehicle sensor(s) function to sense information about the vehicle 102 itself. In one or more arrangements, the vehicle sensor(s) include accelerometers, gyroscopes, an inertial measurement unit (IMU), a dead-reckoning system, a global navigation satellite system (GNSS), a global positioning system (GPS), a mode select sensor, a speed sensor, a wheel rotation (e.g., wheel slip) sensor, wheel angle sensors, an inclinometer, and a steering angle sensor, among others.

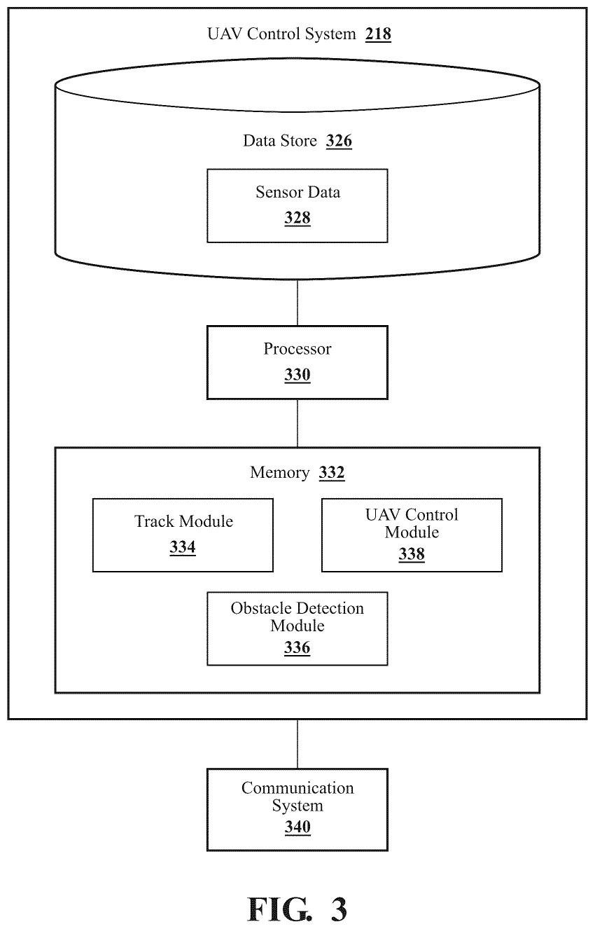

The sensor system 220 may also include one or more environment sensors that sense the surrounding environment (e.g., external) of the vehicle 102. As an example, in one or more arrangements, the sensor system 220 includes one or more radar sensors, one or more LiDAR sensors, one or more sonar sensors (e.g., ultrasonic sensors), and/or one or more cameras (e.g., monocular, stereoscopic, RGB, infrared, etc.). As described above, the UAV control system 218 may determine a vehicle location and a vehicle pose and detect obstacles near the vehicle 102 based on this information. Examples of such are provided below in connection with FIG. 3.

Similarly, the UAV 104 may include a sensor system 222, the output of which may be used to guide the UAV 104. As with the vehicle sensor system 220, the UAV control system 218 may use the output of the UAV sensor system 222 to 1) determine the location of the vehicle 102, 2) determine the pose of the vehicle 102, and 3) identify objects in the vicinity of the vehicle 102. Of particular relevance, the UAV sensor system 222 may include one or more environment sensors such as those described above. As described above, the UAV control system 218 may determine a vehicle location and a vehicle pose and detect obstacles near the vehicle 102 based on this information.

In an example, the UAV control system 218 may rely on a combination of the vehicle sensor system 220 output and the UAV sensor system 222 output. Doing so may provide a more accurate representation of the conditions. For example, a machine vision image processing of UAV camera images alone may provide a rough estimate of the pose of the vehicle 102. When coupled with measurements from vehicle sensors such as accelerometers and/or inclinometers, the UAV control system 218 may make a more accurate estimate of the pose of the vehicle 102.

As described above, the UAV control system 218 generates commands for the UAV 104. The commands may originate from user-generated commands or system-generated commands. For example, a user may input commands at the HMI 106 of the vehicle 102 and transmit such to the UAV 104. As described above, the commands may be of various types, including flight and image capture commands.

In some examples, the commands may not originate from the vehicle 102. For example, the UAV 104 orientation and position commands may originate from the UAV control system 218 itself, which may instruct the UAV 104 to change orientation and/or position based on a detected pose of the vehicle 102 and/or detected obstacles along the path that the vehicle 102 is navigating. The UAV control system 218 receives these commands, translates or otherwise processes the commands, and transmits such to the UAV 104.

As described above, images and/or video streams captured by the camera 224 of the UAV 104 may be transmitted to the HMI 106 of the vehicle 102 via the UAV control system 218. A communication system may facilitate the transmission of the sensor data, commands, and images between the UAV control system 218 and the UAV 104. In one embodiment, the communication system communicates according to one or more communication standards. For example, the communication system can include multiple different antennas/transceivers and/or other hardware elements for communicating at different frequencies and according to respective protocols. In one arrangement, the communication system communicates via a communication protocol, such as WiFi, dedicated short-range communication (DSRC), BLUETOOTH®, or another suitable protocol for communicating between the vehicle 102 and other entities in the cloud environment such as a UAV 104. Moreover, the communication system, in one arrangement, further communicates according to a protocol, such as global system for mobile communication (GSM), Enhanced Data Rates for GSM Evolution (EDGE), Long-Term Evolution (LTE), 5G, or another communication technology that provides for the vehicle 102 communicating with various remote devices (e.g., a cloud-based server). In any case, the UAV control system 218 can leverage various wireless communication technologies to provide communications to other entities, such as members of the cloud-computing environment.

FIG. 3 illustrates one embodiment of the UAV control system 218 that is associated with capturing images of a vehicular environment by a vehicle-tracking UAV 104. The UAV control system 218 is shown as including a processor 330. In the example where the UAV control system 218 is within the vehicle 102, the processor 330 may be a processor of the vehicle 102, the UAV control system 218 may include a separate processor from the processor of the vehicle 102, or the UAV control system 218 may access the processor 330 through a data bus or another communication path that is separate from the vehicle 102. In one or more arrangements, the processor(s) 330 can be a primary/centralized processor of the vehicle 102 or may be representative of many distributed processing units. For instance, the processor(s) 330 can be an electronic control unit (ECU). Alternatively, or additionally, the processors include a central processing unit (CPU), a graphics processing unit (GPU), an ASIC, a microcontroller, a system on a chip (SoC), and/or other electronic processing units that support operation of the UAV control system 218.

In one embodiment, the UAV control system 218 includes a memory 332 that stores a track module 334, an obstacle detection module 336, and a UAV control module 338. The memory 332 is a random-access memory (RAM), read-only memory (ROM), a hard-disk drive, a flash memory, or another suitable memory for storing the modules 334, 336, and 338. The modules 334, 336, and 338 are, for example, computer-readable instructions that when executed by the processor 330 cause the processor 330 to perform the various functions disclosed herein. In alternative arrangements, the modules 334, 336, and 338 are independent elements from the memory 332 that are, for example, comprised of hardware elements. Thus, the modules 334, 336, and 338 are alternatively ASICs, hardware-based controllers, a composition of logic gates, or another hardware-based solution.

In at least one arrangement, the modules 334, 336, and 338 are implemented as non-transitory computer-readable instructions that, when executed by the processor 330, implement one or more of the various functions described herein. In various arrangements, one or more of the modules 334, 336, and 338 are a component of the processor(s) 330, or one or more of the modules 334, 336, and 338 are administered on and/or distributed among other processing systems to which the processor(s) 330 is operatively connected.

Alternatively, or in addition, the one or more modules 334, 336, and 338 are implemented, at least partially, within hardware. For example, the one or more modules 334, 336, and 338 may be comprised of a combination of logic gates (e.g., metal-oxide-semiconductor field-effect transistors (MOSFETs)) arranged to achieve the described functions, an ASIC, programmable logic array (PLA), field-programmable gate array (FPGA), and/or another electronic hardware-based implementation to implement the described functions. Further, in one or more arrangements, one or more of the modules 334, 336, and 338 can be distributed among a plurality of the modules 334, 336, and 338 described herein. In one or more arrangements, two or more of the modules 334, 336, and 338 described herein can be combined into a single module.

In one embodiment, the UAV control system 218 includes a data store 326. The data store 326 is, in one embodiment, an electronic data structure stored in the memory 332 or another data storage device and that is configured with routines that can be executed by the processor 330 for analyzing stored data, providing stored data, organizing stored data, and so on. Thus, in one embodiment, the data store 326 stores data used by the modules 334, 336, and 338 in executing various functions.

The data store 326 can be comprised of volatile and/or non-volatile memory. Examples of memory that may form the data store 326 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, solid-state drivers (SSDs), and/or other non-transitory electronic storage medium. In one configuration, the data store 326 is a component of the processor(s) 330. In general, the data store 326 is operatively connected to the processor(s) 330 for use thereby. The term “operatively connected,” as used throughout this description, can include direct or indirect connections, including connections without direct physical contact.

In an example, the data store 326 includes sensor data 328 provided by the vehicle sensor system 220 and/or the UAV sensor system 222, which may include observations of a surrounding environment of the vehicle 102 and/or information about the vehicle 102 itself. In some instances, one or more data stores located onboard the vehicle 102 store at least a portion of the sensor data 328. Alternatively, or in addition, at least a portion of the sensor data 328 can be located in one or more data stores that are located remotely from the vehicle 102.

In general, the data store 326 may store the sensor data 328 relied upon by the UAV control system 218. Specifically, the track module 334 may rely on sensor data 328 to 1) track the location of the vehicle 102 and 2) determine the pose of the vehicle 102. The obstacle detection module 336 may rely on sensor data 328 to detect obstacles on the road, path, or trail traversed by the vehicle 102. The output of these modules 334 and 336 is relied on by the UAV control module 338 to generate flight and other control commands for the UAV 104. Additional detail on how the modules 334, 336, and 338 rely on the different sensor data 328 is provided below in describing the operations of the various modules 334, 336, and 338.

The data store 326 may include data from the vehicle sensor system 220. This data may include vehicle sensor output and environment sensor output. The vehicle sensor output may include output from vehicle sensors such as accelerometers, inclinometers, GPS sensors, mode sensors, and vehicle system sensors. As described below, the UAV control system 218 may use the output of these vehicle sensors to determine vehicle location, vehicle pose, and obstacle characteristics and alter the flight characteristics of the UAV 104.

The data store 326 may also include UAV sensor data 328. That is, the UAV 104 may also be equipped with sensors, the output of which may be used to 1) track the location of the vehicle 102, 2) determine the pose of the vehicle 102, and 2) detect obstacles and terrain features that may alter UAV 104 operation. As an example, the UAV 104 may include a camera 224 that captures images of the vehicle 102. An image processor may identify objects within images, identify their pose, and/or track their movement through a sequence of images or video streams. In the context of the present system, the track module 334 may identify a vehicle 102 in an image and determine its pose within the surrounding environment.

While particular reference is made to particular sensors from which a pose of the vehicle 102 is determined and from which a perception of the surrounding environment is made, the sensor data 328 may include the output of other sensors which allow the UAV control system 218 to 1) track the vehicle 102, 2) identify the pose of the vehicle 102, and 3) identify objects in the surrounding environment of the vehicle 102 and the UAV 104.

As described above, the sensor data 328 may include sensor data from both the vehicle 102 and the UAV 104. As such, the sensor data 328 may represent a fusion of data from multiple sensors to define the location and pose of the vehicle 102 and obstacles more accurately. That is, relying on image analysis alone, the UAV control system 218 may inaccurately estimate the location and pose of the vehicle 102 or may potentially misidentify or mischaracterize an obstacle. By relying on multiple sets of data, i.e., UAV camera images and vehicle sensor data, the UAV control system 218 generates a more accurate indication of the vehicle 102 location and pose and classification of different obstacles. That is, while the output of each sensor system 220 and 222 by itself may allow for estimates of vehicle location, vehicle pose, and obstacle location, size, etc., each by itself may provide a rough or inaccurate estimate of the actual vehicle location, vehicle pose, and obstacle location, size, etc. Accordingly, the present UAV control system 218 relies on a fusion of sensor data from various devices to provide more accurate estimates of vehicle and environmental characteristics.

In one embodiment, the data store 326 stores the sensor data 328 along with, for example, metadata that characterizes various aspects of the sensor data 328. For example, the metadata can include location coordinates (e.g., longitude and latitude), relative map coordinates or tile identifiers, time/date stamps from when the separate sensor data 328 was generated, and so on.

The UAV control system 218 includes a track module 334 that includes instructions that cause the processor 330 to track a location and a pose of a moving vehicle 102 to which a UAV 104 is operatively connected. As described above, the UAV control system 218 maintains the UAV 104 at a predetermined fixed distance from the vehicle 102. As maintaining the UAV 104 a fixed distance away from the vehicle 102 is dependent upon the location of the vehicle 102 over time, the track module 334 may, in various fashions, track the location of the vehicle 102 to be able to generate a UAV flight path that aligns with the path of the vehicle 102.

The tracking may occur in a variety of ways. In one example, the track module 334 periodically receives sensor data indicative of the vehicle location. For example, a vehicle 102 may include a GPS sensor that communicates with satellites to precisely triangulate the position of the GPS sensor and the vehicle 102. A vehicle processor may record, log, and transmit the positional information (e.g., latitude and longitude or other locational coordinates) of the vehicle 102 over time. The track module 334 may periodically receive this location information and transmit such to the UAV control module 338 to generate a flight path for the UAV 104 based on such.

The predetermined fixed distance between the UAV 104 and the vehicle 102 may be set in various ways. In one example, a user, via the HMI 106, selects a predetermined location for the UAV 104 relative to the vehicle 102. As with the vehicle 102, the location of the UAV 104 may be defined by location coordinates. In this example, the predetermined distance and a bearing angle between the vehicle 102 and the UAV 104 may be calculated based on the location coordinates of the vehicle 102 and the UAV 104. This predetermined distance and bearing angle may be provided to the UAV control module 338 to operate the UAV 104 and maintain both.

In another example, the predetermined distance and bearing angle may be set in another fashion via the HMI 106. For example, a user may select a position for the UAV 104 from a set of predetermined positions and distances. In either case, based on the tracked vehicle location and determined distance and bearing angle between the UAV 104 and the vehicle 102, the UAV control module 338 generates a flight path for the UAV 104 that matches the path of the vehicle 102 while maintaining the predetermined distance between them.

With regards to tracking the pose of the vehicle 102, as described above, the orientation of the UAV 104 and the operating parameters of the UAV camera 224 may be selected based on the pose of the vehicle 102. That is, rather than simply tracking the location of the vehicle 102 and flying relative to the tracked vehicle 102, the UAV 104 position and orientation may be selected based on the angular position of the vehicle (e.g., the vehicle yaw, roll, or pitch). Doing so ensures that a selected region of a vehicle 102, which a user desires to view, is clearly depicted within a field of view of the display presented on the HMI 106.

The track module 334 may track the pose of the vehicle 102 using different methods. In one example, the track module 334 tracks the pose of the vehicle 102 based on vehicle sensor system 220 data. For example, a vehicle 102 may include sensors such as gyroscopes, inclinometers, etc., that indicate a roll, pitch, and/or yaw of the vehicle 102. The sensor data 328 from one or multiple sensors may be transmitted to the track module 334. The track module 334 may combine and interpret this sensor data to define an overall pose of the vehicle 102. That is to say, the overall pose of the vehicle 102, that is, the vehicle's six degrees of freedom pose within an environment (i.e., x-position, y-position, z-position, yaw, pitch, and roll), may be determined based on the output of various vehicle sensors such as gyroscopes, inclinometers, accelerometers, and other sensors.

In another example, the track module 334 may analyze the images captured by a UAV camera 224 to determine the pose of the vehicle 102. For example, the track module 334 may include a machine vision image processor that can analyze images to identify objects within an image and identify the characteristics of the object (i.e., size, shape, position, etc.) and the relative position of those objects within an image. As such, the machine vision image processor may infer, estimate, or calculate the pose of the vehicle 102 from an image of the vehicle 102.

This image information alone, or when used in conjunction with the vehicle sensor information, allows the track module 334 to determine the pose, in three-dimensional space, of the vehicle 102. In one example, the track module 334 may combine (e.g., average, weighted average) or fuse the estimated pose of the vehicle 102 as determined from 1) the UAV camera images and 2) the vehicle sensors.

As such, the track module 334 includes instructions that cause the processor 330 to track the location and pose of the moving vehicle 102 based on 1) vehicle sensor data, 2) UAV sensor data, or 3) a combination of the vehicle sensor data and the UAV sensor data. By relying on a combination or fusion of sensor data from the vehicle sensor system 220 and the UAV sensor system 222, the track module 334 provides a more accurate estimate of the vehicle pose. That is, the track module 334 relies on different types of data points. The fusion of the different data points increases the accuracy of any determination of the pose of the vehicle 102. As described above, this output may be provided to a UAV control module 338, which controls the operational parameters of the UAV 104 (e.g., the flight parameters and/or camera operational parameters) based on such.

The UAV control system 218 also includes an obstacle detection module 336, which includes instructions that cause the processor 330 to detect an obstacle in the flight path of the UAV 104 and control the UAV 104 to avoid the obstacle. As with the vehicle 102, the UAV 104 may include environment sensors such as radar sensors, LiDAR sensors, sonar sensors, or cameras that detect the environment around the UAV 104. When an object is detected in the flight path of the UAV 104, the UAV control module 338 may generate control signals to alter the flight path of the UAV 104 to avoid the obstacle.

In an example, the UAV control module 338 may generate instructions that cause the UAV 104 to navigate around the obstacle but maintain a target object of interest in the field of view of the camera 224 of the UAV 104. That is, altering the flight path of the UAV 104 to avoid a particular obstacle may alter the field of view of the camera 224 such that the vehicle 102 or environment in front of the vehicle 102 falls out of the field of view of the camera 224. In an example, the UAV control module 338 may alter flight characteristics to prevent the target feature from falling out of the field of view. For example, an image processor of the UAV control system 218 may be able to identify objects and track them through a sequence of images. Accordingly, in this example, while deviating from a flight path, the image processor may identify a particular target feature and alter UAV flight parameters (e.g., UAV yaw and camera angle) to ensure the target object remains in the frame, notwithstanding the altered flight path. Thus, an intended image subject (e.g., the vehicle 102, the environment in front of the vehicle, or a particular area of the vehicle 102) is maintained in view while the UAV 104 avoids an obstacle in the flight path.

In another example, rather than fly to avoid an obstacle in the flight path of the UAV 104, the UAV control system 218 may alter a flight path to head towards an obstacle along the path that the vehicle 102 is traveling. As described above, the vehicle 102 may encounter certain obstacles which, while navigable, may require additional driver attention and concentration. The obstacle detection module 336 includes instructions that, when executed by the processor 330, cause the processor 330 to identify, based on sensor data 328, an obstacle along the path traveled by the moving vehicle 102. The detected obstacle may take various forms, including side-sloped hills 108, boulders or other elevated obstructions 110, gullies or ravine sidewalls 112, downsloping hills 114, and low-clearance areas 116. While particular reference is made to particular obstacles, various other types may be detected. Once detected, the UAV 104 is directed to a region near the obstacle to provide the driver with images via the HMI 106 so that the driver can fully perceive the obstacle and ensure proper navigation.

The obstacle detection module 336 may detect obstacles based on different types of sensor data 328 and/or the fusion of different sensor data 328. In one example, the sensor data 328 may be environment sensor data collected from the vehicle sensor system 220 or the UAV sensor system 222. For example, the vehicle 102 and/or UAV 104 may include environment sensors such as cameras, LiDAR sensors, radar sensors, or sonar sensors that depict the environment. In this example, the obstacle detection module 336 may include a machine vision image processor that analyzes the output of these environment sensors to detect, identify, and characterize a particular obstacle.

In another example, the obstacle detection module 336 may rely on vehicle sensor data to detect, identify, and characterize an obstacle. A few examples are provided.

In some examples, the obstacle detection module 336 may identify an obstacle based on data describing the activity of the vehicle wheel. For example, when a wheel encounters a low traction surface such as ice, sand, or loose gravel, the wheel may spin at an increased rotational speed. Accordingly, the obstacle detection module 336 may identify an obstacle based, at least in part, on wheel sensors.

As another example, the obstacle detection module 336 may identify an obstacle based on the pitch, yaw, or roll of a vehicle 102. For example, based on a detected pitch and the amount of the pitch of the vehicle 102, the obstacle detection module 336 may determine that the vehicle 102 is on a sloped hill. Accordingly, the obstacle detection module 336 may identify an obstacle based, at least in part, on the output of inclinometers, gyrsocopes, or accelerometers.

As another example, when navigating particular obstacles, a driver may manipulate the steering wheel in particular patterns or sequences. For example, rapid and incremental counterrotation of the steering wheel may indicate that the driver is attempting to navigate an obstruction, such as a boulder, or is trying to become unstuck from a high-centered position. In this example, the obstacle detection module 336 may identify an obstacle based, at least in part, on the steering wheel rotational data from a steering wheel sensor.

Another example is the speed of the vehicle 102. For example, when navigating obstacles, the speed of the vehicle 102 may be reduced as compared to when the vehicle 102 is navigating a clear and smooth portion of the road or trail. Thus, the obstacle detection module 336 may detect, identify, and classify an obstacle based, at least in part, on the speed of the vehicle 102.

As another example, a vehicle 102 may have a variety of selectable terrain “modes” that each establish particular operating parameters for the vehicle 102 based on a selected mode. Examples include but are not limited to “rock,” “sand,” “mud,” “ice,” and “loose gravel.” In this example, the obstacle detection module 336 may detect, identify, and classify the obstacle, based at least in part, on the selected mode of the vehicle 102 and/or the associated operating parameters of the vehicle 102.

In an example, the obstacle detection module 336 includes instructions that cause the processor 330 to identify the obstacle based on at least one of the vehicle sensor data, UAV sensor data, or a combination of the vehicle sensor data and the UAV sensor data. That is, the obstacle detection module 336 may combine sensor data (e.g., vehicle sensor data and image data) to detect, identify, and classify obstacles. For example, the obstacle detection module 336 may analyze vehicle sensor data, vehicle environment data, and UAV environment sensor data to detect, identify, and characterize obstacles along the path the vehicle is traveling.

As specific examples, the obstacle detection module 336 may determine that an encountered obstacle is a rock/boulder based on 1) the vehicle 102 being in a “rock” multi-terrain mode, 2) a large inclinometer bounce, and 3) low vehicle speed. As another example, the obstacle detection module 336 may determine that an encountered obstacle is a sand/dust region based on 1) the vehicle being in a “mud,” “sand,” or “loose gravel” multi-terrain mode, 2) an amount of wheel sleep, and 3) a steering direction. As another example, the obstacle detection module 336 may determine that the vehicle 102 is encountering a drop-off based on 1) UAV height sensors and 2) a vehicle direction of travel. As yet another example, the obstacle detection module 336 may determine that the obstacle is a gully or ravine based on side ultrasonic measurements of the vehicle environment sensors. Note that while particular reference is made to particular vehicle sensors that facilitate the detection, identification, and classification of an obstacle, other vehicle sensor outputs and any combination of vehicle sensor outputs may also be used.

In one approach, the obstacle detection module 336 implements and/or otherwise uses a machine-learning algorithm. A machine-learning algorithm generally identifies patterns and deviations based on previously unseen data. In the context of the present application, a machine-learning obstacle detection module 336 relies on some form of machine learning, whether supervised, unsupervised, reinforcement, or any other type of machine learning, to identify patterns in sensor data 328 from the vehicle sensor system 220 and the UAV sensor system 222 and detects, identifies, and characterizes the obstacles based on 1) the currently collected sensor data 328 and 2) in some examples a comparison of the currently collected sensor data 328 to historical data characterizing obstacles. As such, the inputs to a machine-learning obstacle detection module 336 include the sensor data 328 and, in some examples, training data such as sensor data for previously detected obstacles, whether by the vehicle 102 or a fleet of other vehicles.

In one configuration, the machine learning algorithm is embedded within the obstacle detection module 336, such as a convolutional neural network (CNN) or an artificial neural network (ANN) to perform obstacle detection and classification over the sensor data 328 from which further information is derived. Of course, in further aspects, the obstacle detection module 336 may employ different machine learning algorithms or implement different approaches for performing the sensory overload classification, which can include logistic regression, a naïve Bayes algorithm, a decision tree, a linear regression algorithm, a k-nearest neighbor algorithm, a random forest algorithm, a boosting algorithm, and a hierarchical clustering algorithm among others to generate sensory overload classifications. Other examples of machine learning algorithms include but are not limited to deep neural networks (DNN), including transformer networks, convolutional neural networks, recurrent neural networks (RNN), Support Vector Machines (SVM), clustering algorithms, Hidden Markov Models, and so on. It should be appreciated that the separate forms of machine learning algorithms may have distinct applications, such as agent modeling, machine perception, and so on.

Moreover, it should be appreciated that machine learning algorithms are generally trained to perform a defined task. Thus, the training of the machine learning algorithm is understood to be distinct from the general use of the machine learning algorithm unless otherwise stated. That is, the UAV control system 218 or another system generally trains the machine learning algorithm according to a particular training approach, which may include supervised training, self-supervised training, reinforcement learning, and so on. In contrast to training/learning of the machine learning algorithm, the UAV control system 218 implements the machine learning algorithm to perform inference. Thus, the general use of the machine learning algorithm is described as inference. As such, the obstacle detection module 336, in some examples relying on machine learning, receives the sensor data 328 as input and outputs an identified obstacle.

The UAV control system 218 includes a UAV control module 338 that includes instructions to cause the processor 330 to 1) control the UAV 104 based on the location and the pose of the moving vehicle 102 to fly along a flight path at a predetermined distance relative to the moving vehicle 102 and 2) control the UAV 104 to depart from the flight path to capture images of the obstacle. That is, in general, the UAV control module 338 includes instructions that cause the processor 330 to generate commands that are transmitted, via the communication system 340, to the UAV 104. The commands may take a variety of forms, including UAV positional commands, UAV orientation commands, and camera commands each of which are based on the location of the vehicle 102, the pose of the vehicle 102, and the detected obstacles.

As described above, in one example the track module 334 tracks the location of the vehicle 102, for example, by periodically receiving location information from a location sensor of the vehicle 102. In this example, the UAV control module 338 may receive the time-based location information for the vehicle 102 and one or more parameters defining the relative position of the UAV 104 to the vehicle 102 (e.g., coordinates of the UAV 104 and/or a predetermined position and distance relative to the vehicle 102). The UAV control module 338 may generate instructions that cause the UAV 104 to maneuver while maintaining a predetermined distance and position relative to the vehicle 102. For example, as described above, the relative position information between the UAV 104 and the vehicle 102 may include a distance (as calculated based on the UAV coordinates and vehicle coordinates) and a bearing angle. As the track module 334 periodically sends the location information for the vehicle 102, the UAV control module 338 updates the position of the UAV to maintain the distance and bearing angle.

While flying a predetermined distance from the vehicle 102, the UAV 104 may be oriented differently. In one example, the camera 224 of the UAV 104 is pointed toward the vehicle 102 to provide images of the vehicle 102 as the vehicle 102 traverses the road or trail and encounters various obstacles. Such a view may give the driver a more complete view of the obstacle so that the driver may safely and efficiently navigate the road or trail. In this example, the camera 224 may maintain focus on the vehicle 102 based on machine vision. That is, a machine vision image processor may analyze the images captured by the camera 224 of the UAV 104 and alter the flight path of the UAV 104 to maintain the vehicle 102 within the field of view of the camera 224 and, in one particular example, at a relative position within a frame of the camera 224.

In another example, the camera 224 of the UAV 104 is pointed away from the vehicle 102, for example, towards the environment in front of the vehicle 102. That is, the UAV control module 338 may include instructions that cause the processor 330 to orient the UAV 104 in a forward-facing direction to provide guidance imagery to a display of the moving vehicle 102. In this example, the track module 334 includes instructions to track the location and the pose of the moving vehicle 102 based on vehicle position data (i.e., location information) received from the moving vehicle 102. That is to say, when the camera 224 is not facing the vehicle 102, non-image data defining the vehicle 102 location is used to track the location.

The UAV control module 338 also controls the UAV 104 based on the pose of the vehicle 102. That is, the UAV control module 338 causes the processor 330 to 1) orient the UAV 104 relative to the vehicle 102 based on the pose of the vehicle 102 and 2) set an operating parameter of a camera 224 of the UAV 104 based on the pose of the vehicle 102. When vehicle pose is not accounted for in UAV positioning, the vehicle 102 and the surface over which the vehicle 102 is traveling (e.g., paved road or unpaved off-road trail) may be inadequately depicted in captured images. For example, a trail surface may be littered with ruts and boulders, and a driver may be interested in viewing the trail surface across which the vehicle 102 is about to travel and sets the UAV 104 to fly in front of the vehicle 102 and face the vehicle 102. However, as the vehicle heads down a sloped surface, the body of the vehicle 102 may obscure the surface in an image/stream captured by a UAV 104 that is level with the vehicle 102. Accordingly, the UAV control module 338 may lower the position of the UAV 104 so that the front end of the vehicle 102 and road or trail surface (along with its ruts and boulders) are readily captured.

In another example, if the vehicle 102 is rolled to one side, it may be preferred to alter the height of the UAV 104 to adequately capture an image or video stream of the vehicle 102. For example, if the vehicle 102 has a roll angle such that the passenger side of the vehicle 102 is elevated and the UAV is controlled to capture images of the passenger side of the vehicle 102, it may be desirable to increase the height of the UAV 104 to provide a clear and centered picture of the passenger side of the vehicle 102. By comparison, if the UAV is controlled to capture images of the driver's side of the vehicle 102, it may be desirable to reduce the height of the AUV to provide a clear and centered picture of the driver's side of the vehicle 102.

In these examples, the UAV control module 338 may acquire the pose values from the track module 334 and adjust the flight parameters of the UAV 104. In an example, the change may be based on a mapping stored in the data store 326 or memory 332. For example, the UAV control module 338 may include a mapping between pitch, roll, yaw, angles for the vehicle 102, and corresponding desired flight parameters (e.g., yaw and elevation, for example). Accordingly, when vehicle pose information is received, the UAV control module 338 may select the flight parameters based on such.

In addition to changing the flight parameters of the UAV 104, the UAV control module 338 may adjust the camera operating parameters. Example operating parameters include, but are not limited to, a camera angle, a camera focal point, or a camera zoom level. For example, when lowering the UAV 104 to capture the front end of a downwardly pitched vehicle 102, the UAV control module 338 may adjust the angle of the camera (based on a predetermined configuration, a machine vision system, or other system) to place the front end of the vehicle and road or trail surface in the frame of the images and/or in the center of the frames of the images. As with the flight parameters, the UAV control module 338 may include a mapping between pose and camera parameters. Accordingly, when the vehicle pose information is received, the UAV control module 338 may select the camera parameters based on such.

The flight and camera parameters to vehicle pose mapping may be empirically determined or set by an administrator or technician and may be stored in the memory 332. In any case, when a particular pose is determined, the UAV control module 338 controls the UAV 104 based on the determined parameters.

While particular reference is made to particular operational parameter settings, the UAV control module 338 may set various operational parameters based on a predetermined position at which the UAV 104 is located.

As described above, in addition to changing the flight and camera parameters for the UAV 104, the UAV control module 338 may alter the flight and camera parameters based on detected obstacles, whether in the flight path of the UAV 104 or along the path traveled by the vehicle 102. For example, responsive to a detected obstacle in the flight path of the UAV 104, the UAV control module 338 may alter the flight path to avoid the obstacle. As described above, in some examples, modification of the UAV flight parameters may be performed to maintain a target feature in the field of view of the camera. The specific way in which the UAV 104 avoids the obstacle may be based on the characteristics of the obstacle. For example, if the obstacle is a low clearance region that the UAV 104 may have difficulty navigating (such as due to extensive tree overgrowth), the UAV 104 may fly behind the vehicle 102, allowing the vehicle 102 to create a path through the region.

If the obstacle is a road or trail obstacle, the UAV control module 338 may direct the UAV 104 towards the obstacle to clearly represent the obstacle and its positional relationship to the vehicle 102. In an example, the alteration may be based on the type of obstacle. That is, the obstacle detection module 336 may detect, identify, and classify the obstacle. The UAV control module 338 may include a mapping between classes of obstacles and a desired flight path. For example, if the obstacle is a boulder, the UAV control module 338 may direct the UAV 104 to fly overhead, providing a birds-eye view of the boulder. In another example, if the obstacle is a narrow-walled gully, the UAV control module 338 may direct the UAV 104 towards the front of the vehicle 102, looking back towards the vehicle 102 and more particularly, the space between the vehicle 102 and the narrow-walled gully. Thus, the UAV control module 338 may include a mapping between detected obstacles and flight and camera parameters. Thus, the UAV control system 218 provides UAV-aided vehicle operation, specifically by providing UAV-captured images to an HMI 106 of the vehicle 102 and providing images that account for the pose of the vehicle 102 and that are of obstacles in the vicinity of the vehicle 102, which may require additional attention and consideration to safely navigate.

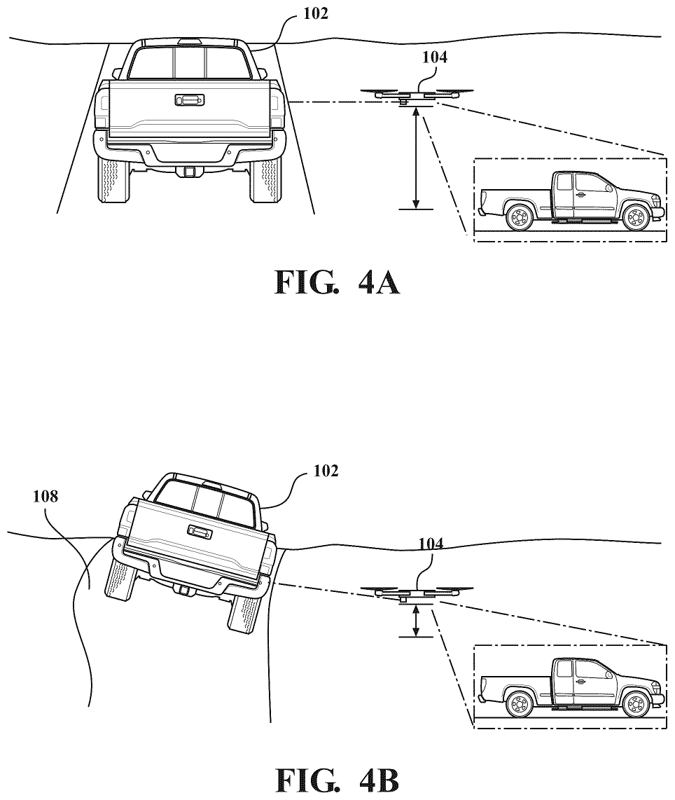

FIGS. 4A and 4B depict a UAV flight adjustment based on a vehicle pose. As described above, the UAV control module 338 may include instructions that cause the processor 330 to orient the UAV 104 relative to the moving vehicle 102 based on the pose of the moving vehicle 102 and orient a camera 224 of the UAV 104 based on the pose of the moving vehicle 102. As depicted in FIG. 4A, the moving vehicle 102 may be traversing along a flat trail. In the example depicted in FIG. 4A, the UAV 104 is traveling a predetermined distance from the vehicle 102 to the side, with the camera 224 facing the vehicle 102 to capture images/video streams of the side of the moving vehicle 102. However, the quality and framing of the view of the side of the vehicle 102 may degrade as the vehicle 102 pitches, as depicted in FIG. 4B. For example, as depicted in FIG. 4A, when on a flat trail, the line of sight between the camera 224 may be perpendicular to the vehicle 102, providing a well-centered image of the side of the vehicle 102. However, when the vehicle 102 pitches, the line of sight may no longer be perpendicular to the subject (i.e., the side of the vehicle 102). This may introduce perspective distortion into the image. In another example, certain features of the vehicle 102 may not be visible or readily visible. For example, in FIG. 4A, the undercarriage or bumper of the vehicle 102 may be visible. By comparison, these same elements may be obscured from view, as depicted in FIG. 4B when the vehicle is rolled to one side.

Accordingly, as described above, based on the tracked pose of the vehicle 102, the UAV control module 338 may alter the UAV 104 flight characteristics. In the example depicted in FIG. 4B, this may include changing the height of the UAV 104. As described above, the adjustment to the flight parameters of the UAV 104 may be based on the specific pose characteristics as measured by the track module 336. The pose-based flight parameter adjustments may be based on machine learning or a pose-to-parameter adjustment mappings database that is empirically populated or populated by an administrator or technician.

The UAV control module 338 may also alter the camera parameters. For example, the UAV control module 338 may change the gimbal angle to point more upwards, as depicted in FIG. 4B to provide a centered view of the side of the vehicle 102. As described above, the adjustment to the camera characteristics of the UAV 104 may be based on the specific pose characteristics as measured by the track module 336. In an example, the adjustment to the camera parameters may be based on machine vision image processing. That is, the UAV control module 338 may include an image processor that tracks the location of a target feature of the vehicle 102. As the UAV 104 height changes, the UAV control module 338 may change the angle of the camera 224 to keep the target feature within the field of view of the camera 224 or at a particular location (e.g., centered) in the field of view. As with the camera parameter adjustments, the pose-based camera parameter adjustments may be based on machine learning or a pose-to-parameter adjustment mappings database that is empirically populated or populated by an administrator or technician.

Note that in FIGS. 4A and 4B, the change to the pose of the vehicle 102 does not affect the vehicle's latitude and longitude. As such, a system that tracks vehicle motion but does not account for the pose of the vehicle 102 may, rather than providing centered and clear pictures of a target feature, provide unclear and potentially blocked images as described above.

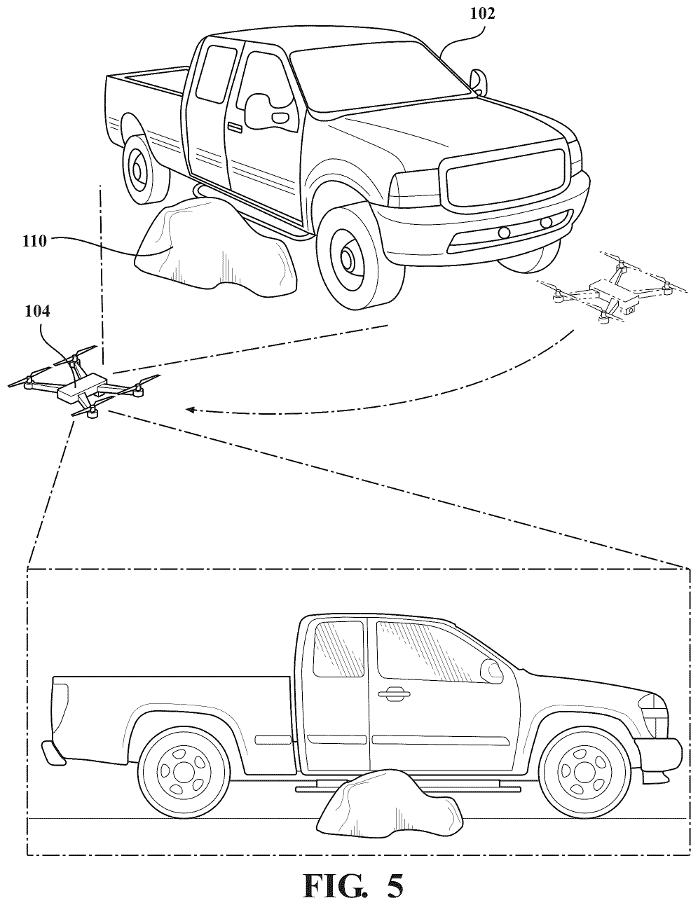

Note also that the adjustments described and depicted in FIGS. 4A and 4B may be based on the characteristics of the obstacle. For example, in both examples depicted in FIGS. 4A, 4B, and 5, the vehicle 102 may pitch to one side. However, based on other sensor outputs, the obstacle detection module 336 may differentiate between the side-sloped hills 108 depicted in FIG. 4B and the obstruction 110 depicted in FIG. 5. For example, a driver may approach the side-sloped hill 108 at a different speed than the obstruction 110. A machine-learning obstacle detection module 336 may be able to differentiate the side-sloped hill 108 from the obstruction 110 based on the different speeds detected while navigating the obstacle. As other examples of differentiating criteria, a different multi-terrain mode and acceleration patterns may be implemented. For example, when navigating the obstruction 110, the driver may cyclically press and release the acceleration pedal to not rapidly accelerate over the obstruction 110. As another example, through machine vision analysis of the camera 224 images, the obstacle detection module 336 may differentiate the obstacles. While particular examples are provided, the obstacle detection module 336, as described herein, may process various items of sensor data to differentiate the obstacle, and the UAV control module 338 may alter the UAV operation based on the differentiated obstacles.

FIG. 5 depicts a UAV 104 deviating from a flight path to capture images of an obstruction 110. As described above, the UAV control module 338 includes instructions that cause the processor 330 to set the UAV 104 position and angle of the camera 224 based on the location and the pose of the moving vehicle 102 and physical properties of the obstacle. For example, as depicted in FIG. 4B, it may be desirable to adjust the height of the UAV 104 when the vehicle 102 is traveling over a side-sloped hill 108. By comparison, when the obstacle is an obstruction 110, it may be desirable to fly the UAV 104 closer to the obstruction 110 so that a driver has a clear and close view of the obstruction 110 and the vehicle 102 frame to precisely navigate the obstruction 110 without causing an impact between the obstruction 110 and the vehicle 102 frame. In the example depicted in FIG. 5, the UAV 104 may initially be flying forward, capturing images in front of the vehicle 102. However, upon identifying and classifying an obstruction 110 near the vehicle 102 frame, the UAV control module 338 may control the UAV 104 to fly towards the obstruction 110 and hover near the obstruction 110 with predetermined flight and camera parameters. Again, as noted above, while particular obstacles and associated flight and camera parameter adjustments are provided as examples, the UAV control system 218 may identify and detect other obstacles and implement other flight and camera parameter adjustments.

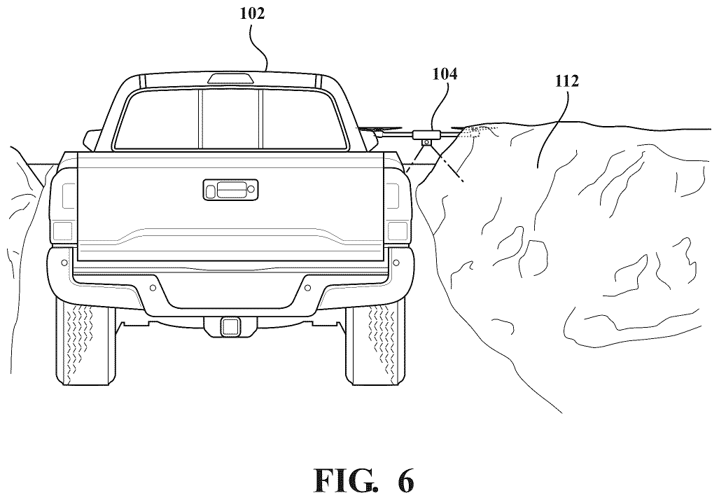

FIG. 6 depicts a UAV 104 deviating from a flight path to capture images of sidewall 112 of a gully or ravine. As described above, one example of an obstacle is a sidewall 112 close to the vehicle 102, as the vehicle 102 may experience when traveling in a narrow canyon or through a ravine or gully. In this example, the UAV 104 may be positioned such that the camera 224 captures images/video stream of the space between the vehicle 102 and the sidewall 112 such that the driver may navigate through the tight space without contacting the sidewall 112 and potentially damaging the vehicle 102.

In this example, the vehicle 102 and/or the UAV 104 may include sensors such as ultrasonic proximity sensors, sonar sensors, LiDAR sensors, radar sensors, or cameras that may detect the sidewall 112. The obstacle detection module 336 may identify the obstacle as a sidewall 112 and identify characteristics of the sidewall 112, such as the distance between the sidewall 112 and the vehicle 102 and the length of the sidewall 112.

This information is transmitted to the UAV control module 338, which may move the UAV 104 to a target position and adjust the camera 224 accordingly. Specifically, while a top-down view may provide a view of the sidewall 112 and the vehicle 102, a driver may intuitively have difficulty interpreting this view. Accordingly, in an example, the UAV control module 338 may navigate the UAV 104 to a position in front of the vehicle 102 and to the side, as depicted in FIG. 6, to provide a view of the space between the sidewall 112 and the vehicle 102. Also, as described above, the position of the UAV 104 may be based on the pose of the vehicle 102. For example, the track module 334 may detect the yaw of the vehicle 102 (i.e., a horizontal plane angle relative to some reference longitudinal angle) and set the yaw of the UAV 104 to match. In this way, the angle of the camera 224 is in line with the side of the vehicle 102 to provide a clear and intuitive representation of the tight space through which the driver is to navigate the vehicle 102. Again, as described above, while FIG. 6 and others depict particular examples of obstacles and remediating camera and flight parameter adjustments, but different obstacles may be detected, and/or different responsive actions may be executed.

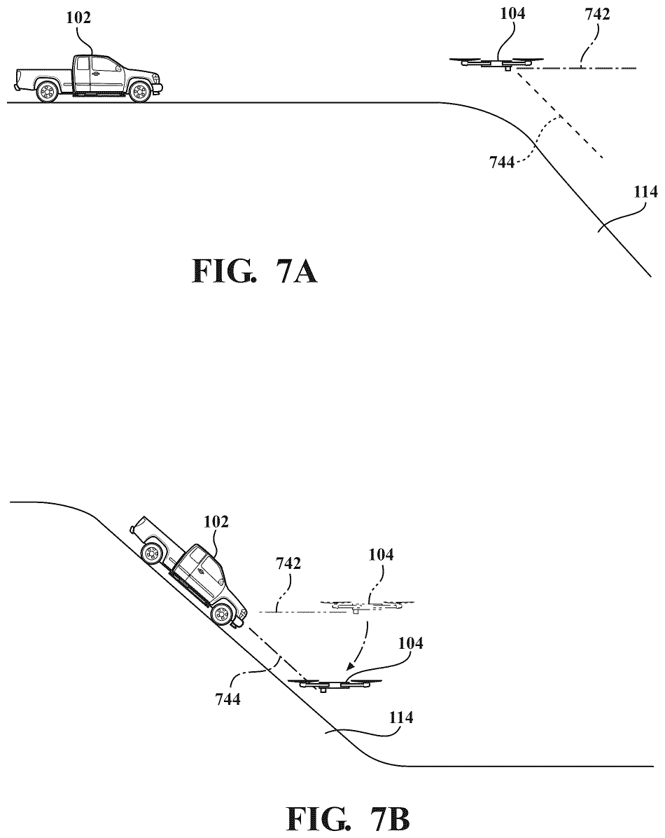

FIGS. 7A and 7B depict a UAV 104 deviating from a flight path as a vehicle 102 travels down a hill 114. Before beginning a descent down a hill 114, a driver may not be able to see obstacles on the hill 114 or at the bottom of the hill 114, notwithstanding the assistance of a UAV 104. For example, as depicted in FIG. 7A, a UAV 104 that is providing forward-facing images to the HMI 106 with the camera pointed forward along a horizontal line of sight 742 may not capture the road or trail nor obstacles on the road or trail, whether the obstacles are on the sloped part of the hill 114 or at the bottom of the hill 114. Accordingly, the UAV control module 338 may alter the flight and/or camera characteristics to provide a more relevant view to the driver through the HMI 106. For example, the UAV control module 338 may angle the camera 224 to have a sloped line of sight 744 that matches or is towards the slope of the hill 114. In an example, the obstacle detection module 336 may detect, identify, and classify the hill 114 and, in an example, determine the slope value of the hill 114. The obstacle detection module 336 may transmit the slope value to the UAV control module 338, which may select an angle of the camera 224 that matches or at least more clearly depicts the slope of the hill 114.

In another example, the UAV 104 may be operating in a vehicle-centric mode where images of the vehicle 102 are transmitted to the HMI 106. In this example, as the vehicle 102 is traveling down a slope, as depicted in FIG. 7B, the body of the vehicle 102 may block a view of the frame of the vehicle 102 if the UAV 104 has a horizontal line of sight 742. The view of the surface/frame proximity may be desirable to allow the driver to navigate around obstacles that may otherwise contact the frame. In this example, the UAV control module 338 may angle the camera to have a sloped line of sight 744 that matches or is towards the slope of the hill 114. Moreover, in this example, the UAV control module 336 may lower the height of the UAV 104 to align more with the front end of the vehicle 102.

In an example, the obstacle detection module 336 may detect, identify, and classify the hill 114 and, in an example, determine the slope value of the hill 114. The obstacle detection module 336 may transmit the slope value to the UAV control module 338, which may select an angle of the camera 224 to match the slope of the hill 114. Thus, in this example, a view of the road or trail and/or vehicle frame is provided to allow the driver to operate the vehicle 102 to not damage or harm the vehicle frame.

In either case, were the orientation of the UAV 104 not based on the pose of the vehicle 102, valuable visual information may not be transmitted to the driver, such as views of obstacles on or near the road or trail. As such, the present system enhances the relevance of visual information captured by the UAV 104 and presented to the driver through the vehicle HMI 106.

While two examples have been provided where the camera angle has been adjusted to provide a more aligned image of the road or trail surface, in other examples, different adjustments may be made. For example, the UAV 104 may change from a forward-facing orientation to a vehicle-facing one.

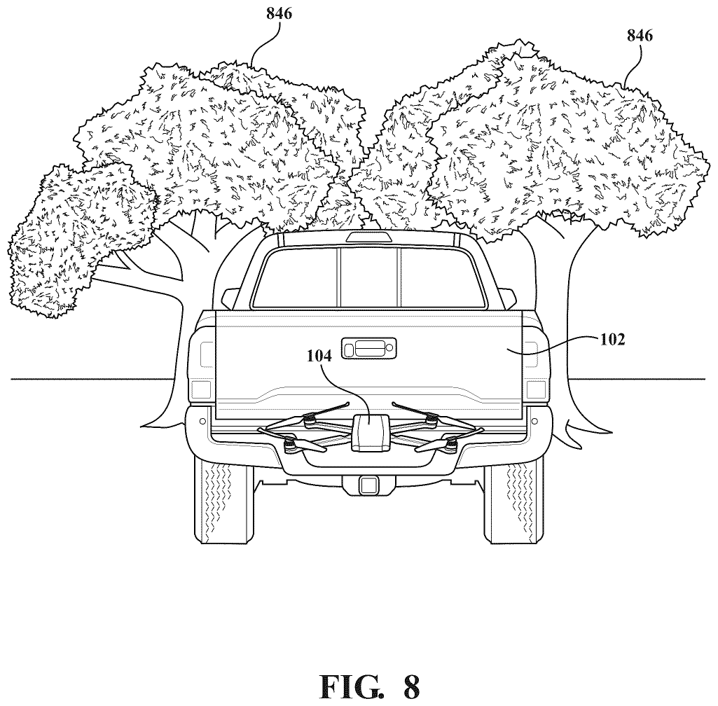

FIG. 8 depicts a UAV 104 following behind the vehicle 102 to avoid an obstacle. As described above, the UAV control module 338 may control the UAV 104 to avoid obstacles in the flight path. However, in some examples, the nature of the obstacle in the flight path may make it particularly difficult to avoid. For example, the vehicle 102 may be driving along a forest trail, and trees 846 may overhang the trail so that the UAV 104 cannot safely navigate around them. Based on this detected situation as determined by the obstacle detection module 336, the UAV control module 338 may direct the UAV 104 to fly behind the vehicle 102 while navigating this region, thus letting the vehicle 102 create a path through the foliage. That is, the obstacle detection module 336 includes instructions to detect an obstacle in the flight path of the UAV 104 and the UAV control module 338 includes instructions to control the UAV 104 to fly behind the moving vehicle 102 until the UAV 104 has passed the obstacle. While particular reference is made to a particular condition triggering the UAV 104 to fly behind the vehicle 102, other conditions may trigger a similar responsive action.

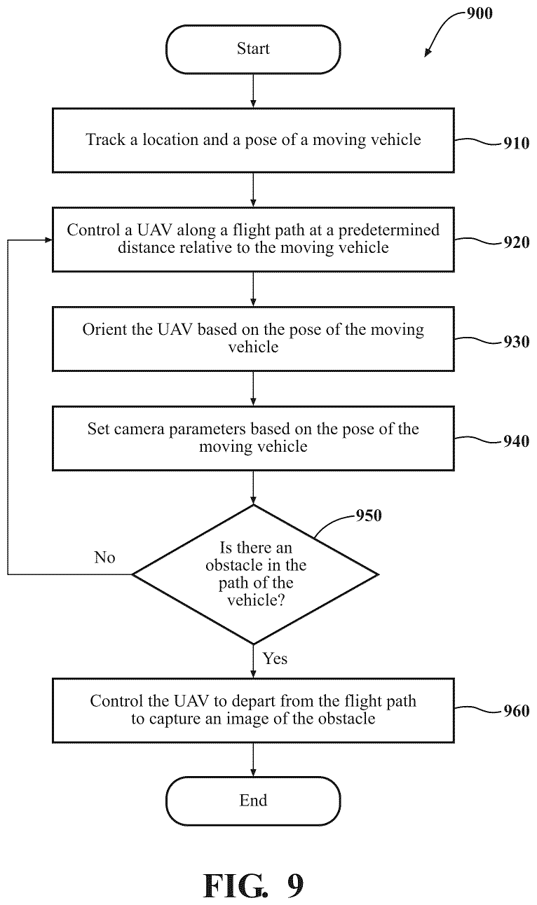

Additional aspects of UAV-assisted vehicle navigation will be discussed in relation to FIG. 9. FIG. 9 illustrates a flowchart of a method 900 that is associated with controlling a UAV 104 to fly a predetermined distance away from a vehicle 102 and deviating from this flight path upon detecting an obstacle. Method 900 will be discussed from the perspective of the UAV control system 218 of FIGS. 2 and 3. While method 900 is discussed in combination with the UAV control system 218, it should be appreciated that the method 900 is not limited to being implemented within the UAV control system 218 but is instead one example of a system that may implement the method 900.

At 910, the track module 334 may track the location and pose of the moving vehicle 102. As described above, each of the vehicle 102 and the UAV 104 may have a variety of sensors, each of which may be used in various fashions. The track module 334 acquires the sensor data 328 from the vehicle sensor system 220 and the UAV sensor system 222. Specifically, the track module 334 may periodically receive location information from the vehicle 102 to allow the track module 334 to track the location of the vehicle 102 over time.

Based on vehicle sensor data, environment data from the vehicle 102, and/or environment data from the UAV 104, the track module 336 may determine the pose of the vehicle 102 as described above. As described above, knowing the pose of the vehicle 102 allows the UAV control system 218 to position the UAV 104 at a location and orientation to ensure clear, centered, and unobstructed images of the target feature of the vehicle 102.

At 920, the UAV control module 338 may control the UAV 104 to fly along a flight path at a predetermined distance relative to the moving vehicle 102. The distance between any two objects (i.e., the vehicle 102 and the UAV 104) may be determined by calculating the Euclidean distance between their respective coordinates. Accordingly, knowing the location information for the vehicle 102 and the selected predetermined distance and bearing angle, the UAV control module 338 may determine the coordinates where the UAV 104 should be at any given time.

At 930, the UAV control system 218, and more particularly the UAV control module 338, orients the UAV 104 relative to the vehicle 102 based on the pose. As an example, the UAV control module 338 may elevate or lower the UAV 104 or change its yaw based on the pose of the vehicle 102. As a particular example, if a vehicle 102 is rolled towards the passenger side, as depicted in FIG. 4B, the UAV control module 338 may lower the UAV 104 on the passenger side of the vehicle 102 to provide better-framed images/video streams of a particular target feature.

In an example, the UAV 104 orientation adjustment may be based on the pose values measured by the vehicle sensors. That is, the UAV control module 338 may include a mapping between pose values and adjustments to the UAV 104 orientation. As described above, as one particular example, a particular roll angle of the vehicle 102 may be mapped to a particular elevation of the UAV 104 above the ground surface. These and other mappings may be determined based on machine learning and/or empirical investigation.

In another example, the adjustment to the UAV 104 orientation may be based on the machine vision image processing of UAV images. For example, the orientation of the UAV 104 (e.g., the height, yaw, etc.) may be adjusted in a trial-and-error fashion or a guided machine-learning fashion until the machine vision image processor identifies the object in the images.

At 940, the UAV control system 218, and more particularly the UAV control module 338, may set camera parameters for the UAV camera 224. That is, based on the pose of the vehicle 102, the UAV control module 338 may adjust the camera parameters, such as a camera angle, camera yaw, etc., to provide a better-framed image/video stream of the target feature.

At 950, the obstacle detection module 336 may determine whether there is an obstacle along the path. In particular, the obstacle detection module 336, based on machine learning in some examples, may detect, identify, and classify obstacles the vehicle 102 encounters as it traverses a road or trail, which detection, identification, and classification may be based on data collected by the vehicle or UAV sensors as described above. If there is no obstacle, the UAV control system 218 continues to track the location and pose of the vehicle 102 and control the UAV 104 accordingly. Thus, the UAV control system 218, in one embodiment, iteratively executes the functions discussed at blocks 910-950 to acquire the sensor data 328 and provide information therefrom.

If there is a detected obstacle in the path of the vehicle 102, at 960 the UAV control module 338 controls the UAV 104 to depart from the flight path to capture an image of the obstacle. As described above, how the UAV 104 is controlled to hover near the obstacle and capture images thereof may be based on the classification of the obstacle. That is, different obstacles may be more clearly depicted using different imaging parameters (e.g., UAV location, camera angle, UAV distance, etc.) As such, based on the type of obstacle as determined by the obstacle detection module 336, the UAV control module 338 may direct the UAV 104 to a region surrounding the obstacle and transmit images of such to the HMI 106 of the vehicle 102. With these images, the driver has a well-framed image of the obstacle, particularly its position relative to the vehicle 102, to aid in navigation around the obstacle.

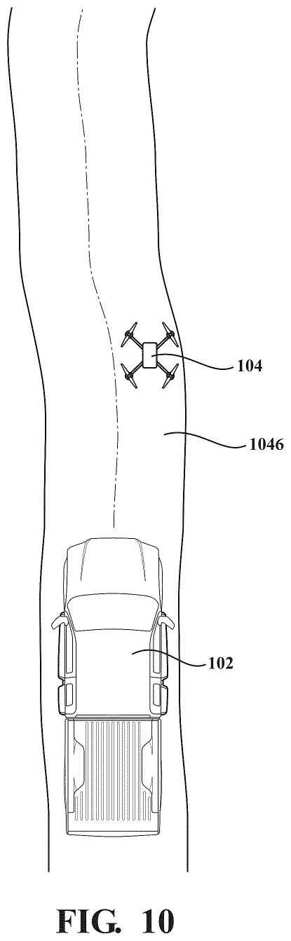

FIG. 10 illustrates a UAV 104 leading a vehicle 102 along a path 1046. As described above, in some examples, the UAV control module 338 may control the UAV 104 to fly in a path ahead of the vehicle 102 and to provide guidance imagery through the HMI 106. In one particular example, the UAV control module 338 includes instructions that cause the processor 330 to 1) identify a path 1046 along which the moving vehicle is traveling and 2) center the UAV 104 on the path 1046. As described above, then traveling along the path 1046, the vehicle 102 may be driving over different surfaces such as a paved road or a dirt, gravel, or otherwise unpaved off-road trail.

As described above, the UAV control system 218 may include a machine-learning image processor that can detect an object in an image. In one example, the object detected is the path 1046, or side markers of the path 1046. For example, the edges of the path 1046 may be defined by different surfaces (e.g., dirt vs. grass and foliage). The image processor may be able to differentiate these surfaces to define the path 1046 and the relative position of the edges of the path 1046. In one particular example, the UAV control system 218 may implement a simultaneous localization and mapping (SLAM) protocol to identify the path 1046 and the position of the UAV 104 relative to the path 1046. Based on these or other systems to detect the edges of the path 1046, the UAV control module 338 may control the UAV 104 to fly in a center of the the path 1046.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-10, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a computer-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. A non-exhaustive list of the computer-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a computer-readable storage medium is, for example, a tangible medium that stores a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing machine-readable instructions that, when executed by the processor, cause the processor to:
track a location and a pose of a moving vehicle to which an unmanned aerial vehicle (UAV) is operatively connected;
control the UAV based on the location and the pose of the moving vehicle to fly along a flight path at a predetermined distance relative to the moving vehicle;
identify, based on sensor data, an obstacle along a path traveled by the moving vehicle; and
control the UAV to depart from the flight path to capture images of the obstacle.

2. The system of claim 1, wherein the machine-readable instructions further comprise machine-readable instructions that, when executed by the processor, cause the processor to:
orient the UAV relative to the moving vehicle based on the pose of the moving vehicle; and
orient a camera of the UAV based on the pose of the moving vehicle.

3. The system of claim 2, wherein:
the machine-readable instruction that, when executed by the processor, causes the processor to orient the UAV relative to the moving vehicle comprises a machine-readable instruction that, when executed by the processor, causes the processor to orient the UAV in a forward-facing direction to provide guidance imagery to a human-machine interface (HMI) of the moving vehicle; and
the machine-readable instruction that, when executed by the processor, causes the processor to track the location and the pose of the moving vehicle comprises a machine-readable instruction that, when executed by the processor, causes the processor to track the location and the pose of the moving vehicle based on vehicle position data received from the moving vehicle.

4. The system of claim 1, wherein the machine-readable instructions further comprise machine-readable instructions that, when executed by the processor, cause the processor to transmit captured images of the moving vehicle to a human-machine interface (HMI) of the moving vehicle.

5. The system of claim 1, wherein the machine-readable instruction that, when executed by the processor, causes the processor to control the UAV to depart from the flight path to capture images of the obstacle comprises a machine-readable instruction that, when executed by the processor, causes the processor to set a UAV position and angle of a camera of the UAV based on the location and the pose of the moving vehicle and physical properties of the obstacle.

6. The system of claim 1, wherein the machine-readable instruction that, when executed by the processor, causes the processor to track the location and the pose of the moving vehicle comprises a machine-readable instruction that, when executed by the processor, causes the processor to track the location and the pose of the moving vehicle based on at least one of:
vehicle sensor data;
a UAV sensor data; or
a combination of the vehicle sensor data and the UAV sensor data.

7. The system of claim 1, wherein the machine-readable instruction that, when executed by the processor, causes the processor to identify the obstacle comprises a machine-readable instruction that, when executed by the processor, causes the processor to identify the obstacle based on at least one of:
vehicle sensor data;
a UAV sensor data; or
a combination of the vehicle sensor data and the UAV sensor data.

8. The system of claim 1, wherein the machine-readable instructions further comprise machine-readable instructions that, when executed by the processor, cause the processor to:
detect an obstacle in the flight path of the UAV; and
control the UAV to avoid the obstacle in the flight path while maintaining a target object of interest in a field of view of a camera of the UAV.

9. The system of claim 1, wherein the machine-readable instructions further comprise machine-readable instructions that, when executed by the processor, cause the processor to:
detect an obstacle in the flight path of the UAV; and
control the UAV to fly behind the moving vehicle until the UAV has passed the obstacle.

10. The system of claim 1, wherein the machine-readable instruction that, when executed by the processor, causes the processor to control the UAV to fly along the flight path comprises a machine-readable instruction that, when executed by the processor, causes the processor to:
identify at least one of a road or a trail along which the moving vehicle is traveling; and
center the UAV on the road or the trail.

11. A non-transitory machine-readable medium comprising instructions that, when executed by a processor, cause the processor to:
track a location and a pose of a moving vehicle to which an unmanned aerial vehicle (UAV) is operatively connected;
control the UAV based on the location and the pose of the moving vehicle to fly along a flight path at a predetermined distance relative to the moving vehicle;
identify, based on sensor data, an obstacle along a path traveled by the moving vehicle; and
control the UAV to depart from the flight path to capture images of the obstacle.

12. The non-transitory machine-readable medium of claim 11, wherein the instructions further comprise instructions that, when executed by the processor, cause the processor to:
orient the UAV relative to the moving vehicle based on the pose of the moving vehicle; and
orient a camera of the UAV based on the pose of the moving vehicle.

13. The non-transitory machine-readable medium of claim 12, wherein:
the instruction that, when executed by the processor, causes the processor to orient the UAV relative to the moving vehicle comprises an instruction that, when executed by the processor, causes the processor to orient the UAV in a forward-facing direction to provide guidance imagery to a human-machine interface (HMI) of the moving vehicle; and
the instruction that, when executed by the processor, causes the processor to track the location and the pose of the moving vehicle comprises an instruction that, when executed by the processor, causes the processor to track the location and the pose of the moving vehicle based on vehicle position data received from the moving vehicle.

14. The non-transitory machine-readable medium of claim 11, wherein the instruction that, when executed by the processor, causes the processor to control the UAV to depart from the flight path to capture images of the obstacle comprises an instruction that when executed by the processor, causes the processor to set a UAV position and angle of a camera of the UAV based on the location and the pose of the moving vehicle and physical properties of the obstacle.

15. The non-transitory machine-readable medium of claim 11, wherein the instruction that, when executed by the processor, causes the processor to track the location and the pose of the moving vehicle comprises an instruction that, when executed by the processor, causes the processor to track the location and the pose of the moving vehicle based on at least one of:
a vehicle sensor;
a UAV sensor; or
a combination of the vehicle sensor and the UAV sensor.

16. The non-transitory machine-readable medium of claim 11, wherein the instructions further comprise instructions that, when executed by the processor, cause the processor to:
detect an obstacle in the flight path of the UAV; and
control the UAV to fly behind the moving vehicle until the UAV has passed the obstacle.

17. A method, comprising:
tracking a location and a pose of a moving vehicle to which an unmanned aerial vehicle (UAV) is operatively connected;
controlling the UAV based on the location and the pose of the moving vehicle to fly along a flight path at a predetermined distance relative to the moving vehicle;
identifying, based on sensor data, an obstacle along a path traveled by the moving vehicle; and
controlling the UAV to depart from the flight path to capture images of the obstacle.

18. The method of claim 17, further comprising:
orienting the UAV relative to the moving vehicle based on the pose of the moving vehicle; and
orienting a camera of the UAV based on the pose of the moving vehicle.

19. The method of claim 17, wherein controlling the UAV to depart from the flight path to capture images of the obstacle comprises setting a UAV position and angle of a camera of the UAV based on the location and the pose of the moving vehicle and physical properties of the obstacle.

20. The method of claim 17, further comprising:
detecting an obstacle in the flight path of the UAV; and
controlling the UAV to avoid the obstacle in the flight path while maintaining a target object of interest in a field of view of the UAV.
